(19) United States
(12) Patent Application Publication
(10) Pub. No.: US 2013/0333211 A1
(43) Pub. Date: Dec. 19, 2013

(54) NETWORK CONNECTOR COMPONENT, NETWORK CONNECTOR AND THEIR PREPARATION METHOD

(71) Applicant: RIIDEA International Corp., Apia (WS)

(72) Inventor: Lung-Hsi LEE, New Taipei City (TW)

(21) Appl. No.: 13/917,122

(22) Filed: Jun. 13, 2013

(30) Foreign Application Priority Data
Jun. 15, 2012 (TW) 101121564

(51) Int. Cl. H01R 43/00

(52) U.S. Cl. CPC H01R 43/00
USPC 29/877

(57) ABSTRACT

A network connector preparation method for making a network connector by: employing a cold drawing technique to draw a metal rod into a thin thickness conducting contact bar, and then processing the thin thickness conducting contact bar to obtain a large amount of metal contacts each having a mating contact portion at one end and a bonding portion at an opposite end on the middle, and then using a contact material strip to carry the metal contacts for electroplating and quick installation in an electrically insulative terminal block for enabling the electrically insulative terminal block with the inserted metal contacts to be further assembled with an electrically insulative housing, an electrical module and a metal shield to form a network connector.

This application claims the priority benefit of Taiwan patent application number 101121564, filed on Jun. 15, 2012.

### BACKGROUND OF THE INVENTION

1. Field of the Invention

The present invention relates to electrical connector technology and more particularly, to a network connector preparation method, which employs a cold drawing procedure to draw a metal rod into a conducting contact bar and stamping and cutting and electroplating techniques to process conducting contact bar into metal contacts, and uses a contact material strip to carry the prepared metal contacts and to insert the carried metal contacts into respective terminal slots in an electrically insulative terminal blocks on metal contacts, and then bend the installed metal contacts into shape, facilitating quick production of network connector components.

2. Description of the Related Art

Following continuous development of computer technology, a modern computer not only provides the functions of computing, word processing and graphic or image editing, but also can be connected to the internet to search remote databases, to make video conferences and to do other works, bringing convenience to people at home or in school or office, Nowadays, the internet has become an integral part of everyday life. For transmission of a network signal between a computer and the internet, network connectors (for example, RJ45 connectors) and network cables must be installed. A conventional RJ45 connector is generally made by: preparing a large amount of copper wire rods, electroplating the round copper wire rods, inserting the round copper wire rods individually into an electrically insulative terminal block, and then cutting off the inserted round copper wire rods subject to a predetermined length, processing posterior contact processing and shaping steps to obtain a network terminal component, and then assembling the network terminal component with other compon to form a finished network connector. This network connector preparation method has drawbacks as follows:
1. Because the round copper wire rods have a smooth peripheral surface, they can easily be moved out of position after insertion into the electrically insulative terminal block, resulting in electrical contact failure and signal transmission instability.
2. Because the round copper wire rods are individually inserted into the electrically insulative terminal block, it is difficult to adjust and control the insertion depth of the round copper wire rods, or to control the angles of the round copper wire rods when bending the round copper wire rods into shape, leading to time and labor waste.

Therefore, it is desirable to provide a method for the preparation of network connectors that saves network connector fabrication time and labor and assures a high level of signal transmission stability.

### SUMMARY OF THE INVENTION

The present invention has been accomplished shed to provide a network connector preparation method that eliminates the drawbacks of the prior art network connector preparation method.

According to one aspect of the present invention, the network connector preparation method employs a cold drawing technique to repeatedly draw a metal rod into a thin thickness conducting contact bar, a stamping technique to stamp the thin thickness conducting contact bar into a metal contact having mating contact portion, an interference portion and a bonding portion and a cutting technique to cut off the metal contact from the thin thickness conducting contact bar, and then uses a contact material strip to carry multiple metal contacts thus prepared for electroplating locally. Thereafter, the contact material strip is cut into multiple cut-off pieces each carrying a predetermined number of metal contacts, and then each cut-off piece is moved to insert the respective metal contacts into respective terminal slots of an upper row or lower row in one respective electrically insulative terminal block, and then the inserted metal contacts at each electrically insulative terminal block are bent into shape.

According to another aspect of the present invention, the electrically insulative terminal block comprises a base panel, a side panel formed integral with the base panel at right angles, a plurality of terminal slots extending through opposing front and rear sides of the side panel and arranged in an upper row and a lower row, and a plurality of terminal grooves located at an outer wall of the base panel and respectively extended from the terminal slots. Further, each metal contact comprises a mating contact portion at one end, a bonding portion at an opposite end, and an interference portion on the middle between the mating contact portion and the bonding portion. After insertion of respective metal contacts in respective terminal slots in the electrically insulative terminal block by means of using the cut-off pieces of the contact material strip, the interference portions of the metal contacts are forced into friction engagement with the peripheral wall of each respective terminal slot of the electrically insulative terminal block, holding the respective metal contacts positively in the respective terminal grooves of the electrically insulative terminal block so that the bonding portions of the installed metal contacts can be accurately bent into shape, suspending in the space between the base panel and side panel of the electrically insulative terminal block.

Further, because multiple metal contacts are carried in respective locating notches of one cutoff piece of the contact material strip prior to insertion into respective terminal slots in the electrically insulative terminal block, the metal contacts can be accurately aligned and simultaneously inserted into respective terminal slots in the electrically insulative terminal block and then accurately bent into the respective terminal grooves in the base panel of the electrically insulative terminal block, shortening metal contact installation time and lowering the network connector component preparation cost.

In an alternate form of the network connector preparation method of the present invention, a clamping tool having a plurality of clamping grooves is used to pick up prepared metal contacts from the contact material strip and to insert the respective metal contacts into respective terminal slots in the electrically insulative terminal block, enhancing metal contact installation accuracy.

### BRIEF DESCRIPTION OF THE DRAWINGS

FIG. 1 is a flow chart of a network connector component preparation method in accordance with a first embodiment of the present invention (I).

FIG. 2 is a flow chart of the network connector component preparation method in accordance with the first embodiment of the present invention (II).

FIG. 3 is a schematic drawing illustrating the performance of a cold drawing step of the network connector component preparation method in accordance with the first embodiment of the present invention.

FIG. 4 is an elevational view of a network connector component made according to the present invention.

FIG. 5 is a schematic drawing illustrating a plurality of metal contacts carried on a contact material strip prior to insertion into respectively terminal slots of an upper row in a side panel of an electrically insulative terminal block during the application of the network connector component preparation method in accordance with the first embodiment of the present invention.

FIG. 6 corresponds to FIG. 5 when viewed from another angle.

FIG. 7 is a schematic drawing illustrating a plurality of metal contacts carried on the contact material strip prior to insertion into respective terminal slots of a lower row in the side panel of the electrically insulative terminal block during the application of the network connector component preparation method in accordance with the first embodiment of the present invention.

FIG. 8 is a sectional side view of the network connector component shown in FIG. 4.

FIG. 9 is a flow chart of a network connector component preparation method in accordance with a second embodiment of the present invention (I).

FIG. 10 is a flow chart of the network connector component preparation method in accordance with the second embodiment of the present invention (II).

FIG. 11 is a schematic drawing illustrating a plurality of metal contacts carried on a clamping tool prior to insertion into respective terminal slots of an upper row in a side panel of an electrically insulative terminal block during the application of the network connector component preparation method in accordance with the second embodiment of the present invention.

FIG. 12 corresponds to FIG. 11 when viewed from another angle.

FIG. 13 is a schematic drawing illustrating a plurality of metal contacts carried on the clamping tool prior to insertion into respective terminal slots of a lower row in the side panel of the electrically insulative terminal block during the application of the network connector component preparation method in accordance with the second embodiment of the present invention.

FIG. 14 is a schematic applied view of still another alternate form of network connector component preparation method in accordance with the present invention (I).

FIG. 15 is a schematic applied view of still another alternate form of network connector component preparation method in accordance with the present invention (II).

FIG. 16 is a schematic applied view of a yet further alternate form of network connector component preparation method in accordance with the present invention.

### DETAILED DESCRIPTION OF THE PREFERRED EMBODIMENT

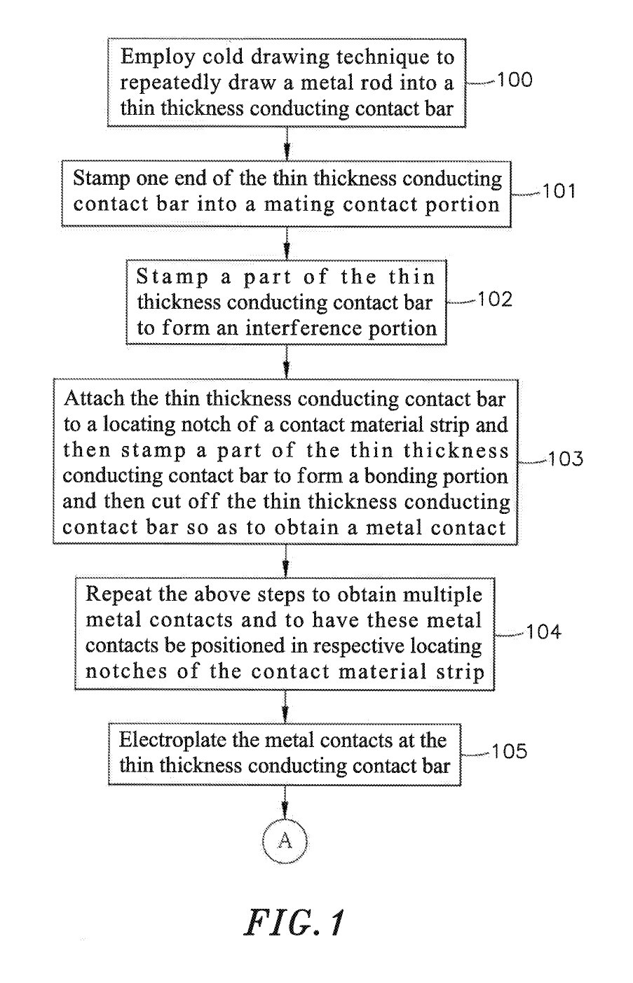

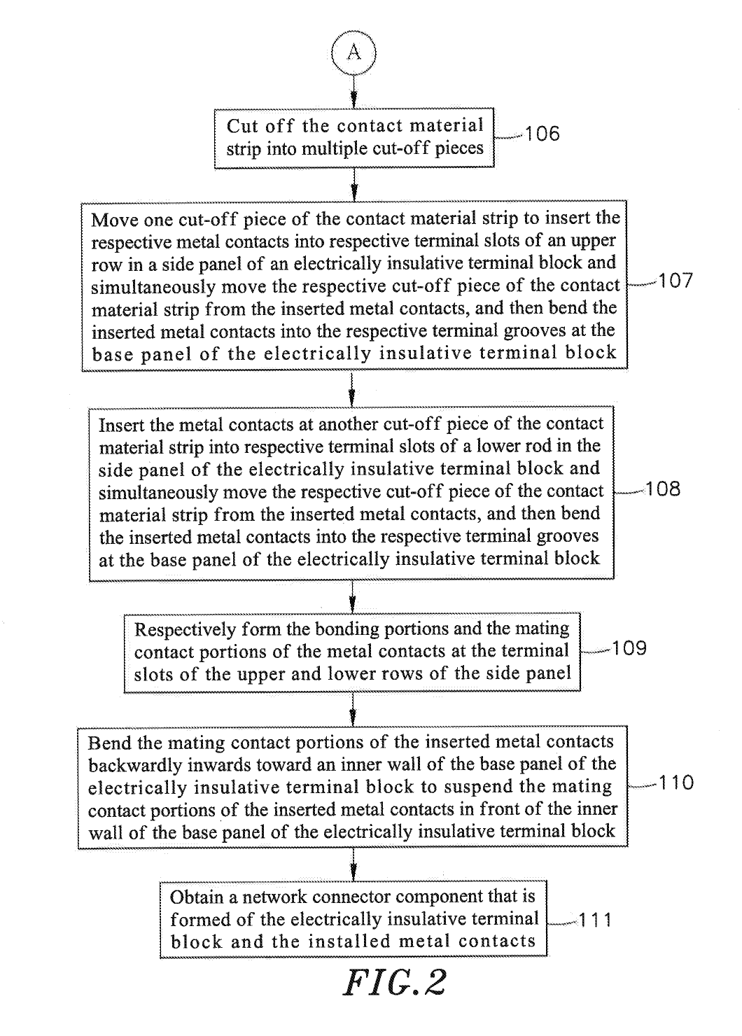

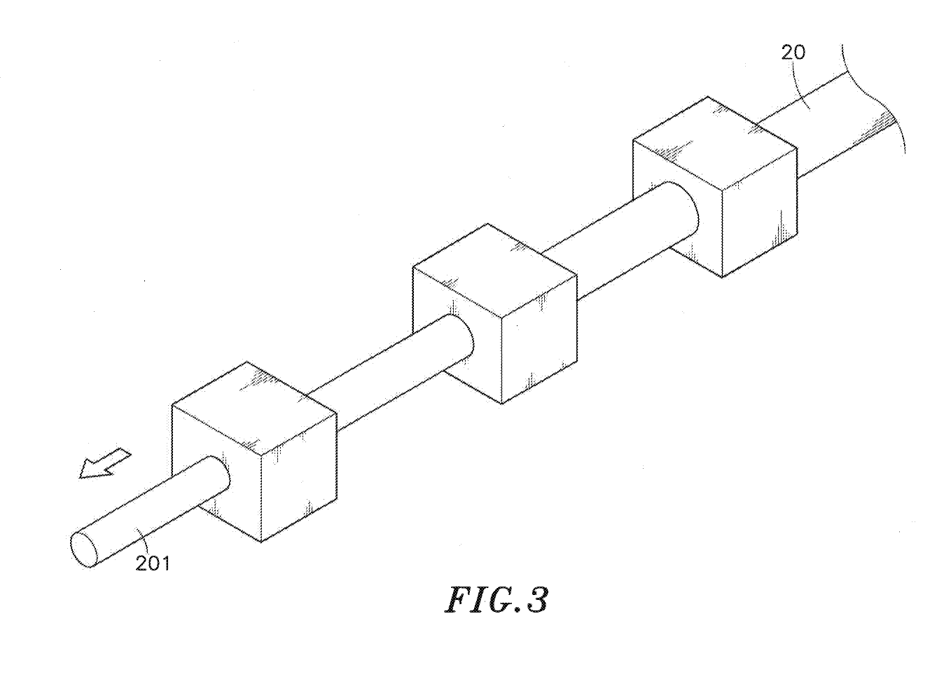

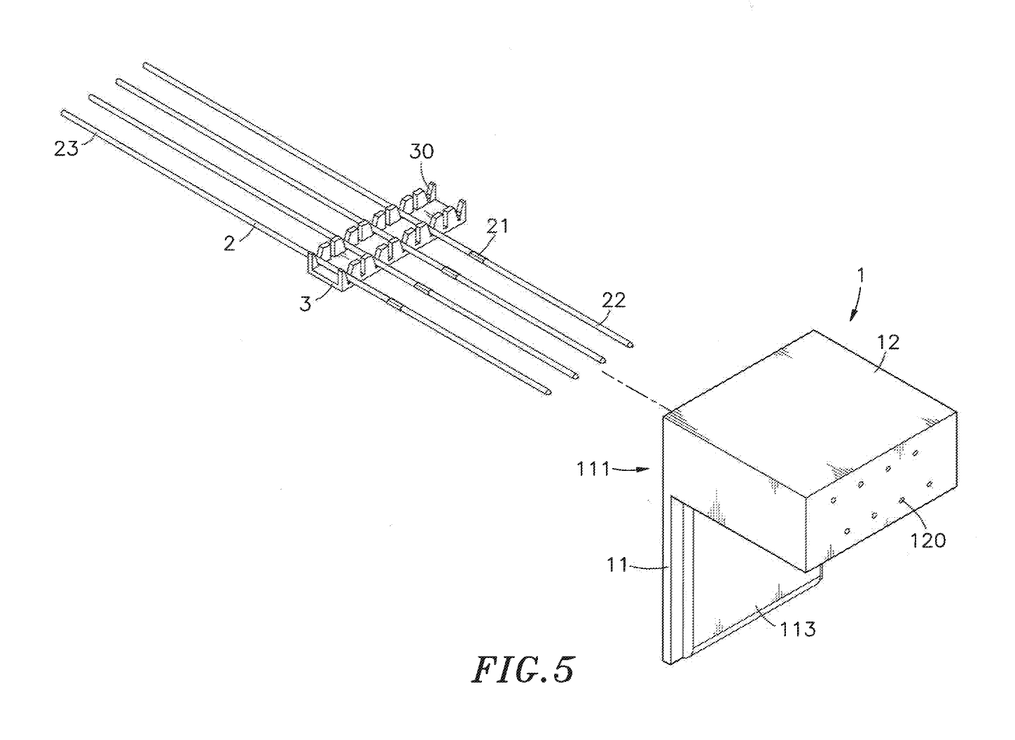

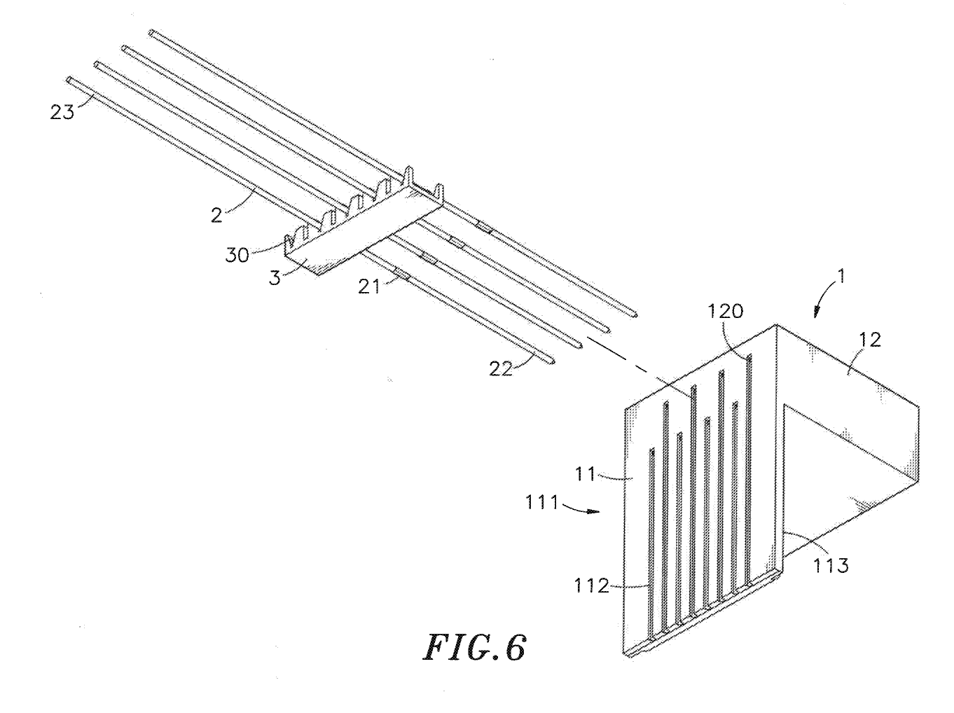

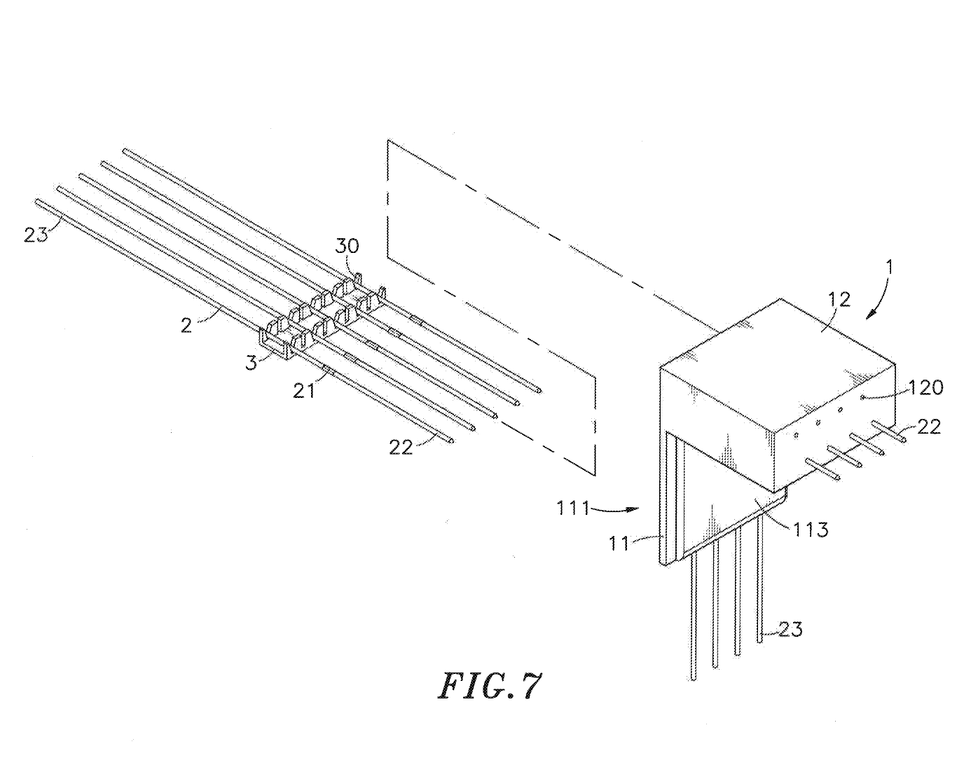

Referring to FIGS. 1-3 and 5-7, a network connector component preparation method in accordance with a first embodiment of the present invention is shown. The network connector component preparation method of this first embodiment comprises the steps of:

(100) employing a cold drawing technique to repeatedly draw a metal rod 20 into a thin thickness conducting contact bar 201;

(101) stamping one end of the thin thickness conducting contact bar 201 into a mating contact portion 23;

(102) stamping a part of the thin thickness conducting contact bar 201 to form an interference portion 21 at a predetermined distance from the mating contact portion 23;

(103) preparing a contact material strip 3 having a plurality of locating notches 30 arranged in parallel, attaching the thin thickness conducting contact bar 201 to one locating notch 30 of the contact material strip 3, stamping a part of the thin thickness conducting contact bar 201 to form a bonding portion 22 at a predetermined distance from the interference portion 21, and then cutting off the thin thickness conducting contact bar 201 so that a finished metal contact 2 formed of the mating contact portion 23 at one end, the bonding portion 22 at an opposite end and the interference portion 21 between the mating contact portion 23 and the mating contact portion 23 is provided and left in one locating notch 30 of the contact material strip 3;

(104) repeating steps (101)˜(103) to obtain a large amount of metal contacts 2 and to have these metal contacts 2 be positioned in respective locating notches 30 of the contact material strip 3;

(105) electroplating the metal contacts 2 at the contact material strip 3;

(106) cutting off the contact material strip 3 subject to a predetermined length so that each cut-off piece of the contact material strip 3 carries a predetermined amount of metal contacts 2 in the respective locating otches 30;

(107) preparing an electrically insulative terminal block 1 that comprises a base panel 11, a side panel 12 formed integral with the base panel 11 at right angles, a plurality of terminal slots 120 extending through opposing front and rear sides of the side panel 12 and arranged in two rows at different elevations and a plurality of terminal grooves 112 located at an outer wall 111 of the base panel 11 and respectively extended from the terminal slots 120, inserting the metal contacts 2 at one cutoff piece of the contact material strip 3 into the respective terminal slots 120 of the upper row in the side panel 12 to suspend the bonding portions 22 of the inserted metal contacts 2 outside the front side of the side panel 12 and the mating contact portions 23 of the inserted metal contacts 2 outside the rear side of the side panel 12 and to position the interference portions 21 of the inserted metal contacts 2 in the respective terminal slots 120, and simultaneously removing the respective cutoff piece of the contact material strip 3 from the inserted metal contacts 2 when inserting the respective metal contacts 2 into the respective terminal slots 120 of the upper row in the side panel 12, and then bending the inserted metal contacts 2 and forcing them into the respective terminal grooves 112 that extend from the terminal slots 120 of the upper row;

(108) inserting the metal contacts 2 at another cut-off piece of the contact material strip 3 into the respective terminal slots 120 of the lower row in the side panel 12 and simultaneously removing the respective cut-off piece of the contact material strip 3 from the inserted metal contacts 2, and then bending these inserted metal contacts 2 and forcing them into the respective terminal grooves 112 that extend from the terminal slots 120 of the lower row;

(109) respectively forming the bonding portions 22 and the mating contact portions 23 of the metal contacts 2 at the terminal slots 120 of the upper and to ows of the side panel 12;

(110) bending the mating contact portions 23 of the inserted metal contacts 2 backwardly inwards toward the inner wall 111 of the base panel 11 to suspend the mating contact portions 23 in front of the inner wall 113 and in the space between the base panel 11 and side panel 12 of the electrically insulative terminal block 1; and

(111) obtaining a network connector component formed of the electrically insulative terminal block 1 and the installed metal contacts 2.

The network connector component formed of the electrically insulative terminal block 1 and the installed metal contacts 2 can be further assembled with an electrically insulative housing, an electrical module and a metal shield to form a network connector.

Further, the interference portion 21 can be obtained by deforming the periphery of each metal contact 2 to form a plurality of peripheral ribs. Further, electroplating the metal contacts 2 can be done by: using a dip electroplating or brush electroplating technique to coat the interference portion 21 and bonding portion 22 of each metal contact 2 wholly or locally with a layer of metal coati

Further, step (102) of stamping a part of the thin thickness conducting contact bar 201 to form an interference portion 21 at a predetermined distance from the mating contact portion 23 is an optional step and can be omitted.

Further, the contact material strip 3 is a narrow, elongated, rectangular strip having a U-shaped cross section with locating notches 30 located at the two parallel upright sidewalls of the U-shaped cross section. Further, after positioning of a large amount of metal contacts 2 in the locating notches 30 of the contact material strip 3, the contact material strip 3 is cut into multiple pieces subject to a predetermined length so that each cut-off piece of the contact material strip 3 carries a predetermined amount of metal contacts 2 in the respective locating notches 30 corresponding to the terminal slots 120 of the upper or lower row in the side panel 12. Thus, the metal contacts 2 at one cut-off piece of the contact material strip 3 can be inserted into the respective terminal slots 120 of the upper or lower row in the side panel 12 at a time. Immediately after insertion of the metal contacts 2 at one cut-off piece of the contact material strip 3 into the respective terminal slots 120 of the upper or lower row in the side panel 12, the respective cut-off piece of the contact material strip 3 is removed from the metal contacts 2. Because multiple metal contacts 2 are inserted into the respective terminal slots 120 of the upper or lower row in the side panel 12 at a time, the inserted metal contacts 2 can be accurately kept in perfect alignment, facilitating further accurate bending operation. After bending, the mating contact portions 23 of the inserted metal contacts 2 are kept at the same angle of inclination, suspending in the space between the base panel 11 and side panel 12 of the electrically insulative terminal block 1 positively.

Further, the metal rod 20 to be drawn into a thin thickness conducting contact bar 201 using a cold drawing technique can be a metal round rod, metal rectangular rod or metal oval rod having a circular, rectangular or oval cross section. Using a cold drawing technique to draw the metal rod 20 into a thin thickness conducting contact bar 201 for making metal contacts 2 does not produce waste material, saving the cost.

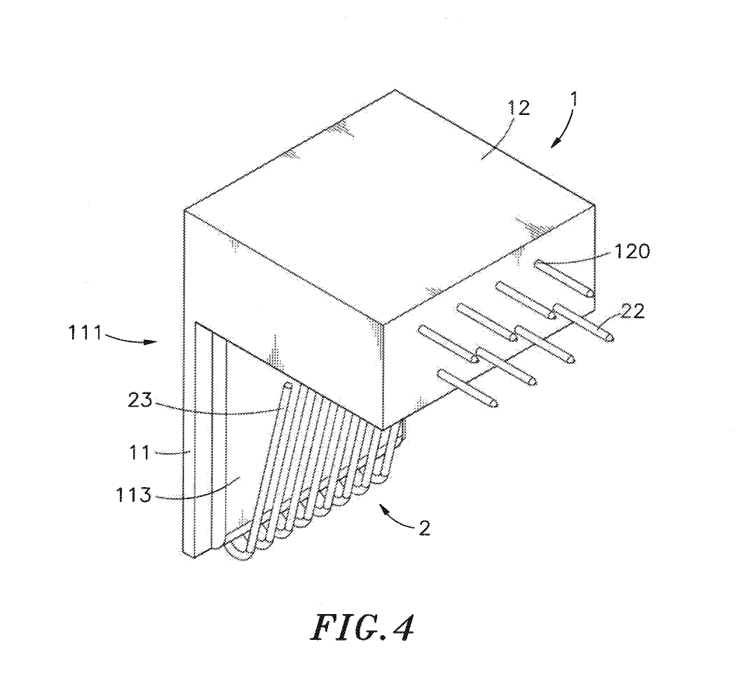

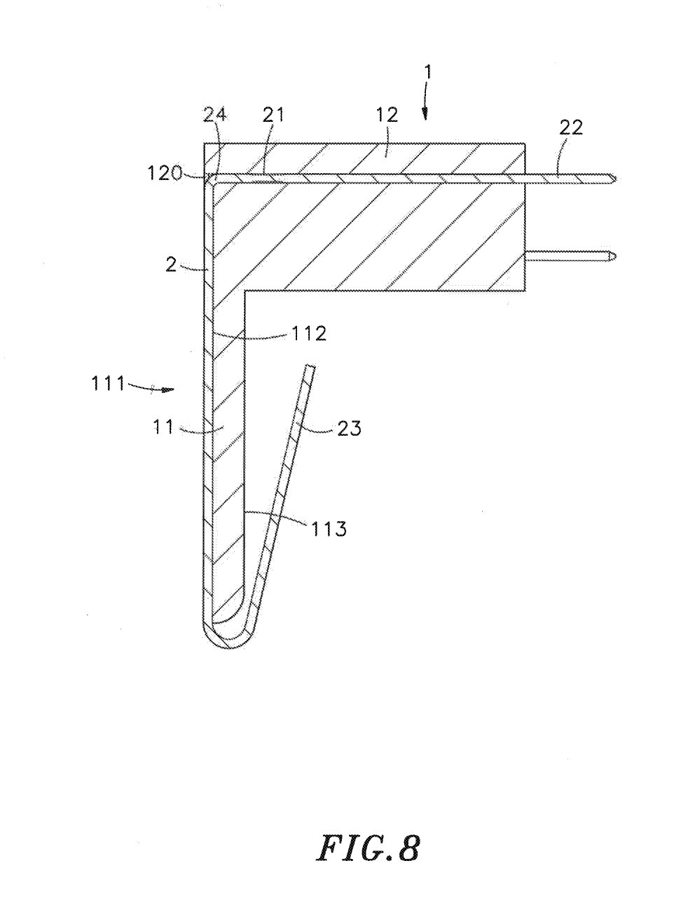

Referring to FIGS. 4 and 8, a network connector component made in accordance with the present invention comprises an electrically insulative terminal block 1 and a plurality of metal contacts 2.

The electrically insulative terminal block 1 is an angled block comprising a base panel 11, a side panel 12 formed integral with the base panel 11 at right angles, a plurality of terminal slots 120 extending through opposing front and rear sides of the side panel 12 and arranged in two rows at different elevations, and a plurality of terminal grooves 112 located at an outer wall 111 of the base panel 11 and respectively extended from the terminal slots 120.

The metal contacts 2 are respectively mounted in the terminal slots 120 of the electrically insulative terminal block 1 and positioned in the terminal slots 120, each comprising a bonding portion 22 disposed at one end thereof, a mating contact portion 23 disposed at an opposite end thereof and an interference portion 21 disposed on the middle between the bonding portion 22 and the mating contact portion 23.

When assembling the network connector component, insert the metal contacts 2 into the terminal slots 120 of the electrically insulative terminal block 1 respectively to force the interference portion 21 of each metal contact 2 into friction engagement with the inside wall of the respective terminal slot 120 of the electrically insulative terminal block 1 and to suspend the bonding portions 22 of the metal contacts 2 outside the front side of the side panel 12 and the mating contact portions 23 of the metal contacts 2 outside the rear side of the side panel 12, bend the respective parts of the metal contacts 2 that suspend outside the rear side of the side panel 12 and force them into the respective terminal grooves 112, and then bend the mating contact portions 23 of the metal contacts 2 backwardly inwards toward the inner wall 111 of the base panel 11 of the electrically insulative terminal block 1 to suspend the mating contact portions 23 in the space between the base panel 11 and side panel 12 of the electrically insulative terminal block 1.

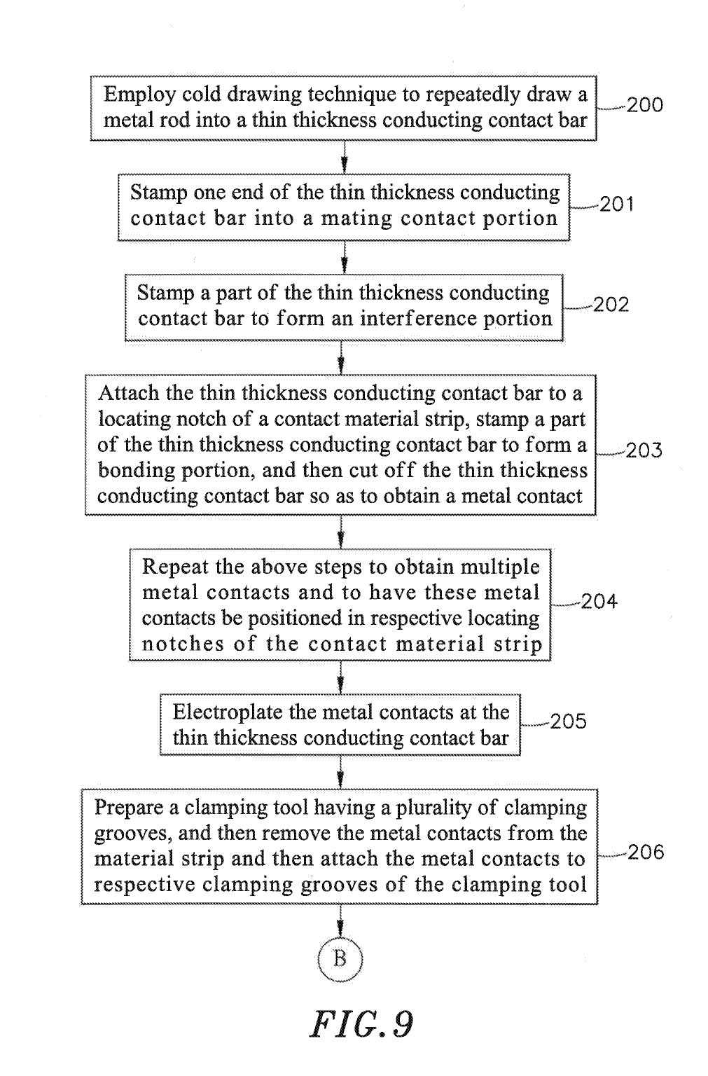

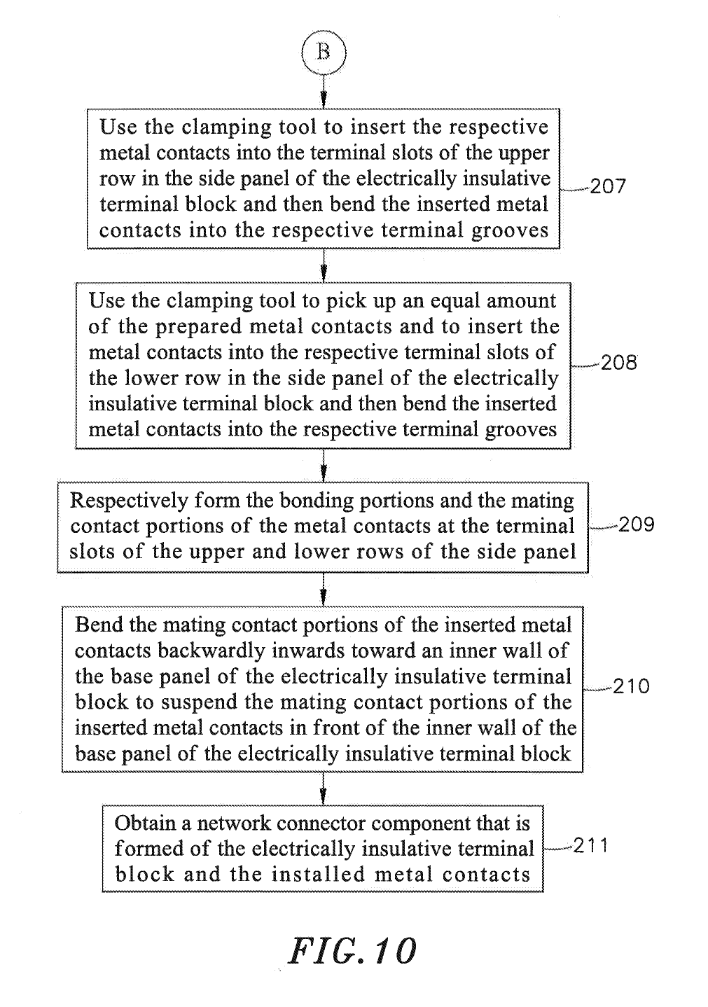

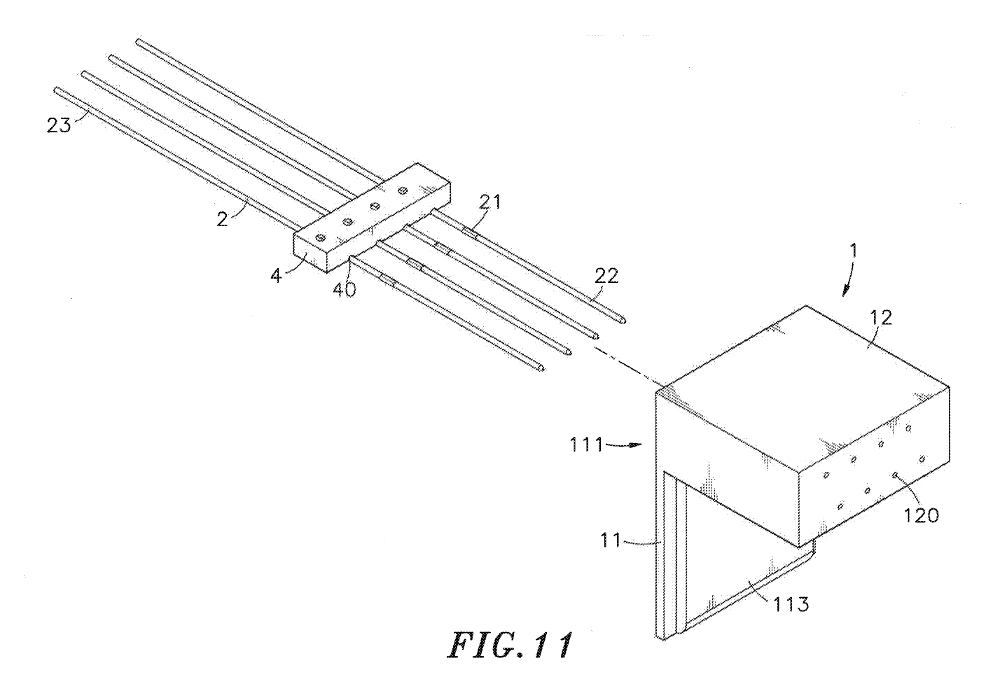

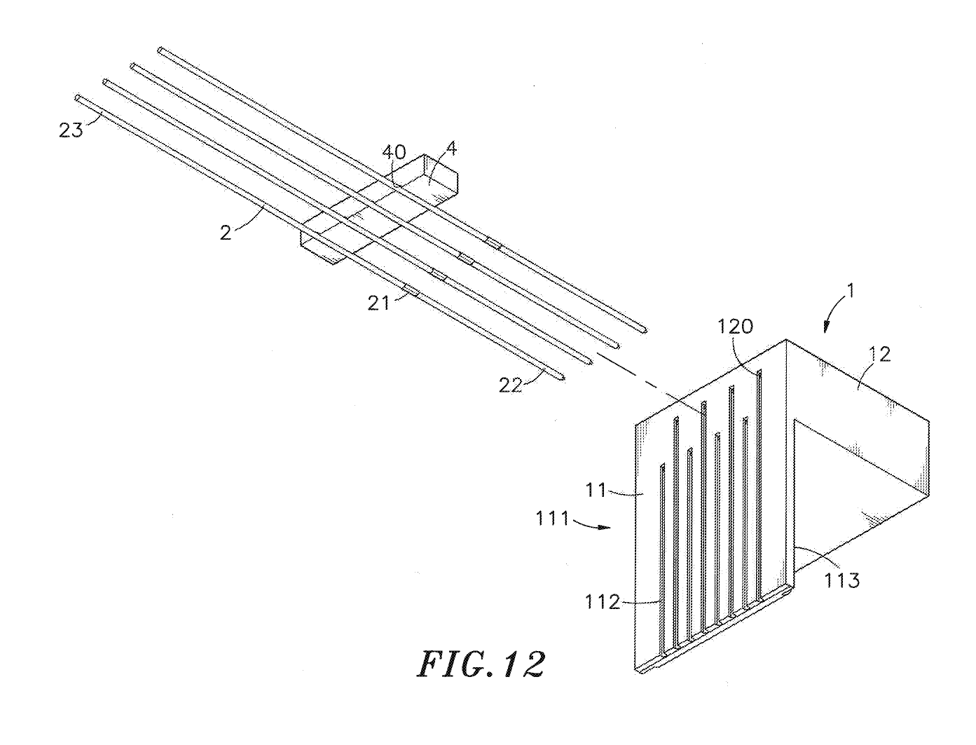

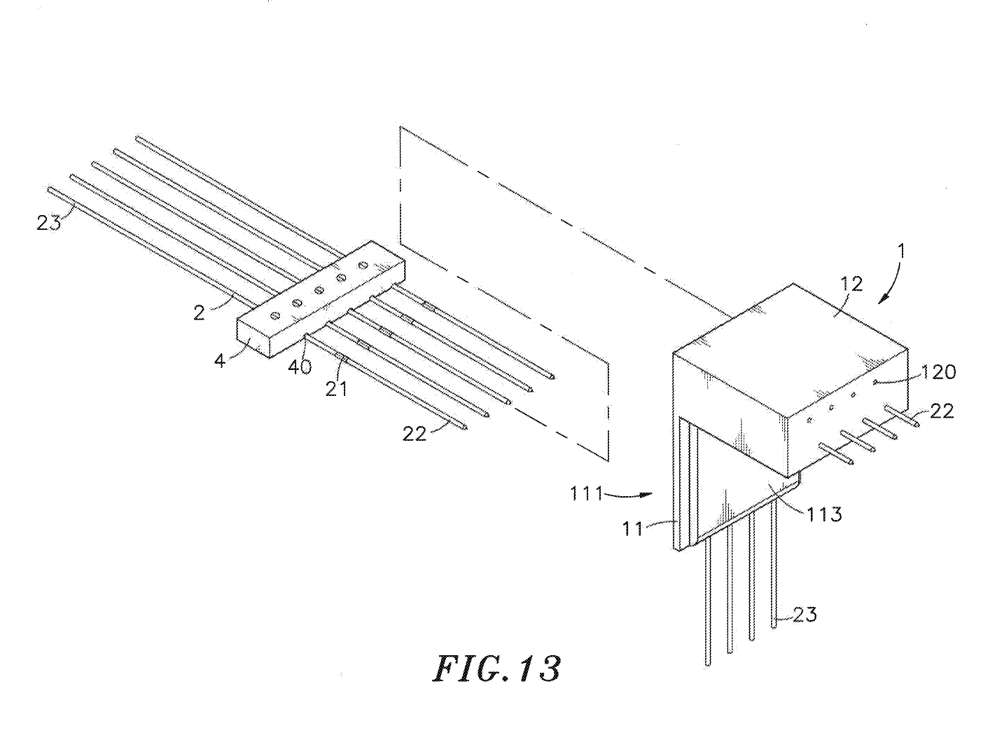

Referring to FIGS. 9-13, a network connector component preparation method in accordance with a second embodiment of the present invention is shown. The network connector component preparation method in accordance with this second embodiment comprises the steps of:

(200) employing a cold drawing technique to repeatedly draw a metal rod 20 into a thin thickness conducting contact bar 201;

(201) stamping one end of the thin thickness conducting contact bar 201 into a mating contact portion 23;

(202) stamping a part of the thin thickness conducting contact bar 201 to form an interference portion 21 at a predetermined distance from the mating contact portion 23;

(203) preparing a contact material strip 3 having a plurality of locating notches 30 arranged in parallel and then attaching the thin thickness conducting contact bar 201 to one locating notch 30 of the contact material strip 3, and then stamping a part of the thin thickness conducting contact bar 201 to form a bonding portion 22 at a predetermined distance from the interference portion 21, and then cutting off the thin thickness conducting contact bar 201 so that a finished metal contact 2 formed of the mating contact portion 23 at one end, the bonding portion 22 at an opposite end and the interference portion 21 between the mating contact portion 23 and the bonding portion 22 is provided and left in one locating notch 30 of the contact material strip 3;

(204) repeating steps (201)˜(203) to obtain a large amount of metal contacts 2 and to have these metal contacts 2 be positioned in respective locating notches 30 of the contact material strip 3;

(205) electroplating the metal contacts 2 at the contact material strip 3;

(206) removing the metal contacts 2 from the material strip 3 and then attaching the metal contacts 2 to respective clamping grooves 40 of a clamping tool 4;

(207) preparing an electrically insulative terminal block 1 that comprises a base panel 11, a side panel 12 formed integral with the base panel 11 at right angles, a plurality of terminal slots 120 extending through opposing front and rear sides of the side panel 12 and arranged in two rows at different elevations and a plurality of terminal grooves 112 located at an outer wall 111 of the base panel 11 and respectively extended from the terminal slots 120, and then moving the clamping tool 4 to insert the respective metal contacts 2 into the respective terminal slots 120 of the upper row in the side panel 12 to suspend the bonding portions 22 of the inserted metal contacts 2 outside the front side of the side panel 12 and the mating contact portions 23 of the inserted metal contacts 2 outside the rear side of the side panel 12 and to position the interference portions 21 of the inserted metal contacts 2 in the respective terminal slots 120, and then bending the inserted metal contacts 2 and forcing them into the respective terminal grooves 112 that extend from the terminal slots 120 of the upper row;

(208) using the clamping tool 4 to pick up an equal amount of the prepared metal contacts 2 and to insert these metal contacts 2 into the respective terminal slots 120 of the lower row in the side panel 12 and then bending these inserted metal contacts 2 and forcing them into the respective terminal grooves 112 that extend from the terminal slots 120 of the lower row;

(209) respectively forming the bonding portions 22 and the mating contact portions 23 of the metal contacts 2 at the terminal slots 120 of the upper and lower rows of the side panel 12;

(210) bending the mating contact portions 23 of the inserted metal contacts 2 backwardly inwards toward the inner wall 111 of the base panel 11 to suspend the mating contact portions 23 in front of the inner wall 113 and in the space between the base panel 11 and side panel 12 of the electrically insulative terminal block 1; and

(211) obtaining a network connector component formed of the electrically insulative terminal block 1 and the installed metal contacts 2.

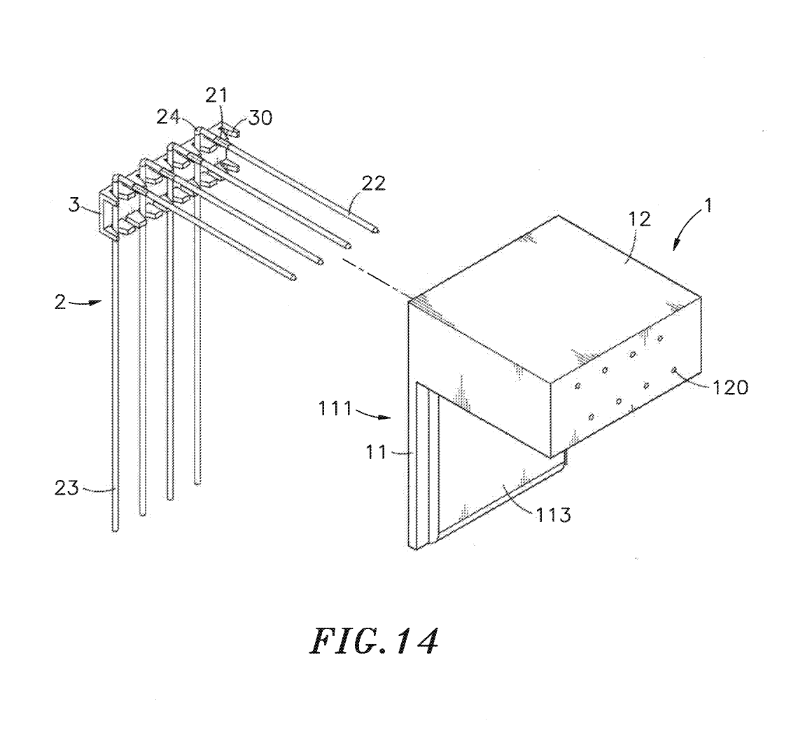

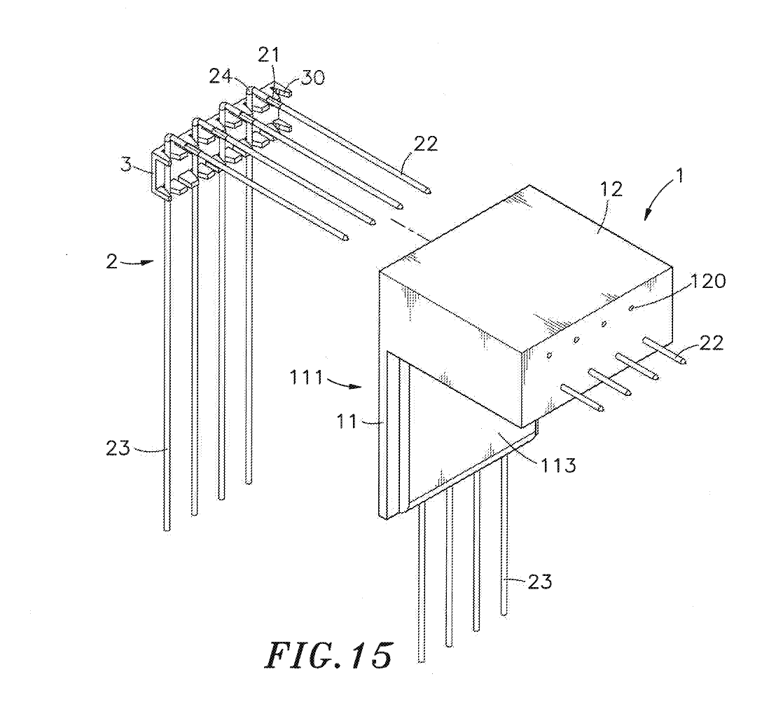

Referring to FIGS. 14 and 15, a network connector component preparation method in accordance with a third embodiment of the present invention is substantially similar to the aforesaid first embodiment with the exception that each metal contact 2 is bent at right angles to form a right-angled portion 24 adjacent to one end of the interference portion 21 opposite to the bonding portion 22, and then the respective angled metal contacts 2 are attached to the respective locating notches 30 of the contact material strip 3. Thus, the angled metal contacts 2 at one cut-off piece of the contact material strip 3 can be inserted into the respective terminal slots 120 of the upper/lower row in the side panel 12 and forced into the respective terminal grooves 112 at the base panel 11 at a time. After insertion of the respective angled metal contacts 2 into the respective terminal slots 120 of the upper/lower row in the side panel 12, the respective angled metal contacts 2 are respectively positioned in the respective terminal grooves 112 at the base panel 11. Thereafter, bend the mating contact portions 23 of the angled metal contacts 2 backwardly inwards toward the inner wall 111 of the base panel 11 to let the angled metal contacts 2 suspend in the space between the base panel 11 and side panel 12 of the electrically insulative terminal block 1. Thus, the electrically insulative terminal block 1 and the angled metal contacts 2 can be quickly assembled to form a network connector component. When a network connector using this design of network connector component is connected to an external mating connector, any pressure imparted by the external mating connector to the mating contact portions 23 of the angled metal contacts 2 does not cause the angled metal contacts 2 to displace or to move out of the electrically insulative terminal block 1.

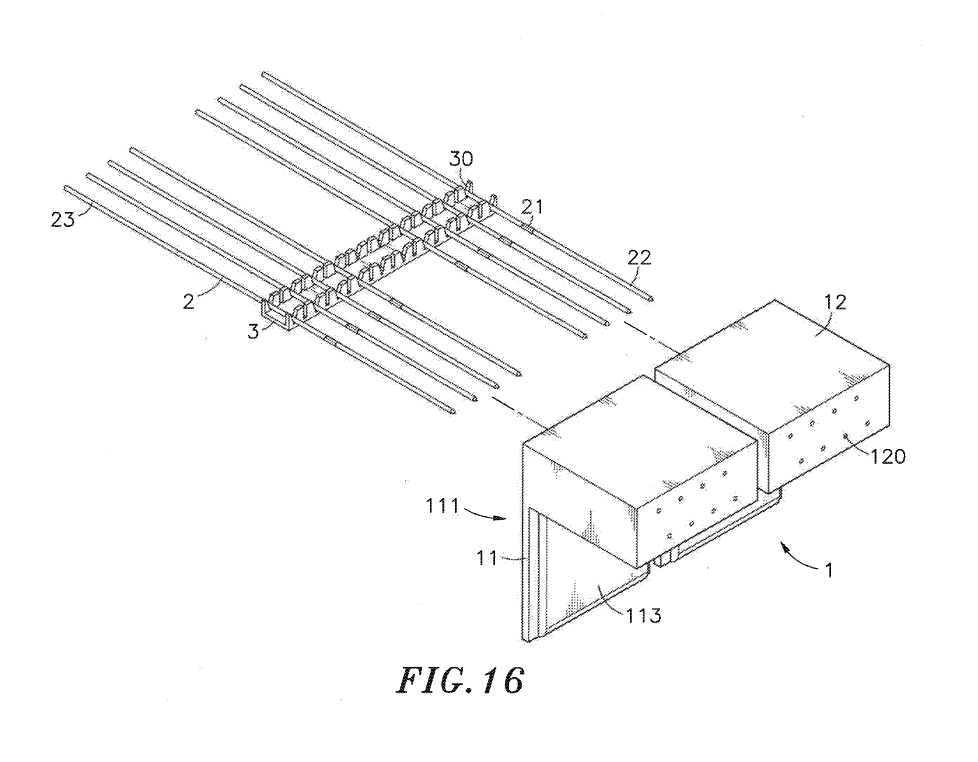

Referring to FIG. 16, during the network connector component processing process, a large amount of metal contacts 2 can be arranged in multiple sets and respectively mounted in the locating notches 30 of the contact material strip 3, and the contact material strip 3 can be moved to insert the multiple sets of metal contacts 2 into the respective terminal slots 120 of the upper row in the side panel 12 of each of a plurality of electrically insulative terminal blocks 1, and then the metal contacts 2 are curved and forced into the terminal grooves 112 at the base panels 11 of the electrically insulative terminal blocks 1 at a time.

As stated above, the invention provides a network connector component preparation method for making a network connector component by: employing a cold drawing technique to repeatedly draw a metal rod 20 into a thin thickness conducting contact bar 201, processing the thin thickness conducting contact bar 201 to provide a mating contact portion 23, an interference portion 21 and a mounting portion 22, attaching the processed thin thickness conducting contact bar 201 to a respective locating notch 30 of a contact material strip 3, cutting off the thin thickness conducting contact bar 201 so that a finished metal contact 2 formed of the mounting portion 22, the interference portion 21 and the mating contact portion 23 is obtained, repeating the aforesaid steps to obtain a large amount of metal contacts 2 at respective locating notches 30 of the contact material strip 3, electroplating the metal contacts 2, moving the contact material strip 3 to insert the metal contacts 2 at two cut-off pieces of the contact material strip 3 into respective terminal slots 120 of an upper row and a lower row the side panel 12 in a proper order, and then bending the installed metal contacts into shape. Subject to friction engagement between the interference portions 21 of the metal contacts 2 and the peripheral walls of the terminal slots 120 of the electrically insulative terminal blocks 1, the metal contacts 2 are firmly positioned in the of electrically insulative terminal blocks 1 and will not be moved out of place during connection of an external mating connector. This method facilitates quick preparation of a large amount of network connector components.

In conclusion, the invention provides a network connector component preparation method for making network connector components, which has the advantages and features as follows:
1. Subject to friction engagement between the interference portions 21 of the metal contacts 2 and the peripheral walls of the terminal slots 120 of the electrically insulative terminal block 1, the metal contacts 2 are firmly positioned in the electrically insulative terminal block 1 for the transmission of network signals stably.
2. A predetermined number of metal contacts 3 can be attached to respective locating notches 30 of a contact material strip 3 and then the contact material strip 3 can be moved to insert the metal contacts 3 into respective terminal slots 120 of the upper or lower row in the side panel 12 of the electrically insulative terminal blocks 1 at a time, facilitating quick installation and shortening the network connector component processing time.
3. After a large amount of metal contacts 2 is prepared and attached to respective locating notches 30 of the contact material strip 3, the metal contacts 2 can be partially or locally electroplated, saving the electroplating cost.

Although particular embodiments of the invention have been described in detail for purposes of illustration, various modifications and enhancements may be made without departing from the spirit and scope of the invention. Accordingly, the invention is not to be limited except as by the appended claims.

What the invention claimed is:

1. A network connector preparation method, comprising the steps of:
(a) employing a cold drawing technique to draw a metal rod into a thin thickness conducting contact bar;
(b) stamping one end of said thin thickness conducting contact bar into a mating contact portion;
(c) preparing a contact material strip having a plurality of locating notches arranged in parallel, attaching said thin thickness conducting contact bar to one said locating notch of said contact material strip, stamping a part of said thin thickness conducting contact bar to form a bonding portion at predetermined distance from said interference portion, and then cutting off said thin thickness conducting contact bar so that a finished metal contact formed of said mating contact portion at one end, said bonding portion at an opposite end is provided and left in one said locating notch of said contact material strip;
(d) repeating steps (b)˜(c) to obtain a large amount of metal contacts and to have these metal contacts be positioned in respective locating notches of said contact material strip;
(e) electroplating said metal contacts at said contact material strip;
(f) cutting off said contact material strip subject to a predetermined length so that each cut-off piece of said contact material strip carries a predetermined amount of said metal contacts in the respective said locating notches;
(g) preparing an electrically insulative terminal block, said electrically insulative terminal block comprising a base panel and a plurality of terminal slots arranged in an upper row and a lower row, inserting said metal contacts at one said cut-off piece of said contact material strip into the respective terminal slots of the upper row in said side panel, and simultaneously removing the respective said cut-off piece of said contact material strip from the inserted metal contacts when inserting the respective said metal contacts into the respective said terminal slots of said upper row in said side panel, and then bending the inserted metal contacts;
(h) inserting the metal contacts at another said cut-off piece of said contact material strip into the respective said terminal slots of said lower row in said side panel and simultaneously removing the respective said cut-off piece of said contact material strip from the inserted metal contacts, and then bending the respective inserted said metal contacts;
(i) respectively forming the bonding portions and the mating contact portions of the metal contacts at said terminal slots of the upper and lower rows of said side panel;
(j) bending the mating contact portions of the inserted metal contacts backwardly inwards toward an inner wall of said base panel to suspend the mating contact portions of the inserted metal contacts in front of an inner wall of said base panel; and
(k) obtaining a network connector component formed of said electrically insulative terminal block and the installed metal contacts.

2. The electrical connector preparation method as claimed in claim 1, wherein said electrically insulative terminal block further comprises a side panel formed integral with said base panel at right angles and a plurality of terminal grooves located at an outer wall of said base panel and respectively extended from said terminal slots for positioning the respective mating contact portions of the metal contacts.

3. The electrical connector preparation method as claimed in claim 2, wherein said metal contacts are a round bar having a circular cross section; said terminal slots and said terminal grooves of said electrically insulative terminal block are configured to fit the configuration of the circular cross section of said metal contacts.

4. The electrical connector preparation method as claimed in claim 2, wherein said metal contacts are a rectangular bar having a rectangular cross section; said terminal slots and, said terminal grooves of said electrically insulative terminal block are configured to fit the configuration of the rectangular cross section of said metal contacts.

5. The electrical connector preparation method as claimed in claim 1, wherein said contact material strip used during step (c) has a U-shaped cross section, and each said locating notch of said contact material strip is located at two parallel upright sidewails of said U-shaped cross section.

6. The electrical connector preparation method as claimed in claim 1, wherein a cold drawing technique is employed to draw a metal rod at least two times to turn the metal rod into a thin thickness conducting contact bar and a part of the thin thickness conducting contact bar is stamped to form an interference portion.

7. The electrical connector preparation method as claimed in claim 1, further comprising a sub step of stamping a part of said thin thickness conducting contact bar to form an interference portion at a predetermined distance from said mating contact portion is to stamp a part of said thin thickness conducting contact bar into a plurality of ribs after step (b).

8. The electrical connector preparation method as claimed in claim 7, wherein the step (e) to electroplate said metal contacts at said contact material strip is to wholly or locally electroplate the interference portion and bonding portion of each said metal contact at said contact material strip by using one of dip electroplating and brush electroplating techniques.

9. The electrical connector preparation method as claimed in claim 1, further comprising step (k) to assemble the network connector component thus obtained with an electrically insulative housing, an electrical module and a metal shield to form a network Connector.

10. The electrical connector preparation method as claimed in claim 1, wherein during step (a) a metal rod is drawn to form a round, rectangular or oval shaped thin thickness conducting contact bar.

11. A network connector preparation method, comprising the steps of:
(a) employing a cold drawing technique to draw a metal rod into a thin thickness conducting contact bar;
(b) stamping one end of said thin thickness conducting contact bar into a mating contact portion;
(c) preparing a contact material strip having a plurality of locating notches arranged in parallel, attaching said thin thickness conducting contact bar to one said locating notch of said contact material strip, stamping a part of said thin thickness conducting contact bar to form a bonding portion at a predetermined distance from said interference portion, and then cutting off said thin thickness conducting contact bar so that a finished metal contact formed of said mating contact portion at one end, said bonding portion at an opposite end and said interference portion between said mating contact portion and said bonding portion is provided and left in one said locating notch of said contact material strip;
(d) repeating steps (b)˜(c) to obtain a large amount of metal contacts and to have these metal contacts be positioned in respective locating notches of said contact material strip;
(e) electroplating said metal contacts at said contact material strip;
(f) cutting off said contact material strip subject to a predetermined length so that each cut-off piece of said contact material strip carries a predetermined amount of said metal contacts in the respective said locating notches;
(g) preparing an electrically insulative terminal block, said electrically insulative terminal block comprising a base panel and a plurality of terminal slots arranged in an upper row and a lower row, removing the metal contacts from said cut-off piece of said material strip and attaching the metal contacts to respective clamping grooves of a clamping tool, moving said clamping tool to insert said metal contacts into the respective terminal slots of the upper row;
(h) using said clamping tool to pick up an equal amount of the prepared metal contacts and to insert the metal contacts into the respective said terminal slots of said lower row;
(i) respectively forming the bonding portions and the mating contact portions of the metal contacts at said terminal slots of the upper and lower rows of said side panel;
(j) bending the mating contact portions of the inserted metal contacts backwardly inwards toward an inner wall of said base panel to suspend the mating contact portions of the inserted metal contacts in front of an inner wall of said base panel; and
(k) obtaining a network connector component formed of said electrically insulative terminal block and the installed metal contacts.
